(19) United States
(12) Patent Application Publication
(10) Pub. No.: US 2018/0097217 A1
(43) Pub. Date: Apr. 5, 2018

(54) SEPARATOR FOR A BATTERY CELL AND BATTERY CELL

(71) Applicant: Robert Bosch GmbH, Stuttgart (DE)

(72) Inventor: Stephan Danko, Stuttgart (DE)

(21) Appl. No.: 15/566,906

(22) PCT Filed: Apr. 20, 2016
(86) PCT No.: PCT/EP2016/058714

§ 371 Date: Oct. 16, 2017

(30) Foreign Application Priority Data
May 6, 2015 (DE) 10 2015 208 435.3

(51) Int. Cl. H01M 2/16

(52) U.S. Cl. CPC H01M 2/1646; H01M 10/0562; H01M 2/1686; H01M 2/1673

(57) ABSTRACT

A separator for separating an anode and a cathode in a battery cell. The separator includes a base material which has a porosity and which may be ionically conductive. An electrolyte layer which is formed by a solid electrolyte and which has a lower porosity than the base material of the separator is provided within the base material of the separator. Moreover, a battery cell that includes at least one separator is described.

### FIELD

The present invention relates to a separator for a battery cell for separating an anode and a cathode in the battery cell, the separator including a base material which has porosity and which may be ionically conductive. Moreover, the present invention relates to a battery cell that includes at least one separator according to the present invention.

### BACKGROUND INFORMATION

Electrical energy may be stored with the aid of batteries. Batteries convert chemical reaction energy into electrical energy. A distinction is made between primary batteries and secondary batteries. Primary batteries are non-rechargeable, while secondary batteries, also referred to as accumulators, are rechargeable. A battery includes one or multiple battery cells.

In particular so-called lithium-ion battery cells and lithium-metal battery cells are used in an accumulator. They are characterized, among other features, by high energy densities, thermal stability, and extremely low self-discharge. Lithium-ion battery cells and lithium-metal battery cells are used, for example, in motor vehicles, in particular in electric vehicles (EVs), hybrid vehicles (HEVs), and plug-in hybrid vehicles (PHEVs).

Lithium-metal battery cells include a positive electrode, also referred to as a cathode, and a negative electrode, also referred to as an anode. The cathode and the anode each include a current collector, to which an active material is applied. The active material for the cathode is a metal oxide, for example. The active material for the anode is metallic lithium, for example.

The active material of the anode contains lithium atoms. During operation of the battery cell, i.e., during a discharging operation, electrons flow in an external circuit from the anode to the cathode. During a discharging operation, lithium ions migrate from the anode to the cathode within the battery cell. During a charging operation of the battery cell, the lithium ions migrate from the cathode to the anode. In the process, the lithium ions are electrochemically deposited on the anode.

The electrodes of the battery cell have a foil-like design and are wound to form an electrode winding, with a separator situated in between which separates the anode from the cathode. Such an electrode winding is also referred to as a “jelly roll.” The electrodes may also be layered one above the other to form an electrode stack.

The two electrodes of the electrode winding or of the electrode stack are electrically connected to poles of the battery cell, also referred to as terminals, with the aid of collectors. A battery cell generally includes one or multiple electrode windings or electrode stacks. In addition, a battery cell includes a liquid or solid electrolyte. The electrolyte is conductive for the lithium ions, and allows transport of the lithium ions between the electrodes.

The battery cell also includes a cell housing that is made of aluminum, for example. The cell housing has a design that is prismatic, in particular cuboidal, for example, and that is pressure-tight. The terminals are situated outside the cell housing. Instead of a solid cell housing, a soft foil may be provided which encloses the electrode winding or electrode stack. Battery cells having this design are also referred to as “pouch cells.”

A problem with conventional lithium-metal battery cells is dendritic growth of the anode. During the recurring charging and discharging operations of the battery cell, lithium may dendritically accumulate on the anode, and from there may grow on the cathode. Growing dendrites may perforate the separator and cause localized short circuits within the battery cell. Growing dendrites may thus significantly reduce the service life of the battery cell, and may even cause thermal destruction of the battery cell, also referred to as “thermal runaway.”

A generic battery cell that includes an anode and a cathode, the active material of the anode containing metallic lithium or a lithium alloy, is described in U.S. Pat. App. Pub. No. 2014/0234726 A1, for example. A porous separator is provided for separating the anode from the cathode. A solid electrolyte is situated between the anode and the separator, and between the cathode and the separator. The solid electrolyte prevents penetration of dendrites.

U.S. Pat. App. Pub. No. 2014/0170503 A1 describes a battery cell that includes a solid electrolyte which is applied as a coating on an electrode of the battery cell.

### SUMMARY

A separator for separating an anode and a cathode in a battery cell is provided, the separator including a base material which has a porosity and which may be ionically conductive. However, the base material of the separator may also be ionically insulating.

The base material of the separator is mesoporous with a mechanically stable design, and has continuous pores. The pores are filled with one or multiple various ionically conductive materials, which may be solid, liquid, or viscous, i.e., semiliquid or gel-like.

According to the present invention, an electrolyte layer that is formed by a solid electrolyte and that has a lower porosity than the base material of the separator is provided within the base material of the separator. The electrolyte layer is thus also mechanically harder than the base material of the separator. Internal pores of the base material of the separator are at least partially covered or closed by the electrolyte layer from one side. The solid electrolyte of the electrolyte layer is ionically conductive.

According to one advantageous embodiment of the present invention, at least one intermediate layer that has a higher porosity than the electrolyte layer is provided within the base material of the separator. The intermediate layer is, thus, also mechanically softer than the solid electrolyte of the electrolyte layer. The intermediate layer is ionically conductive.

According to one advantageous refinement of the present invention, the electrolyte layer is situated between a first intermediate layer and a second intermediate layer. The two intermediate layers, which accommodate the electrolyte layer between them, are used to connect the electrolyte layer to the anode and to the cathode. The two intermediate layers may fill in the remaining pores of the base material of the separator.

According to one advantageous embodiment of the present invention, the at least one intermediate layer is formed as a solid.

According to another advantageous embodiment of the present invention, the at least one intermediate layer is viscous, i.e., semiliquid or gel-like.

According to another advantageous embodiment of the present invention, the at least one intermediate layer is liquid.

The anode includes an anodic active material which preferably adjoins the at least one intermediate layer. The at least one intermediate layer is used to connect the electrolyte layer to the anodic active material. A current collector, which in particular is made of copper, is situated on a side of the anodic active material facing away from the intermediate layer.

The anodic active material of the anode advantageously protrudes into the base material of the separator. This means that remaining pores of the base material of the separator that are not filled in by either the electrolyte layer or by the intermediate layer are filled in with metallic lithium of the anodic active material. A current collector, which in particular is made of copper, is situated on a side of the anodic active material facing away from the intermediate layer.

During charging of the battery cell, lithium ions may thus intercalate into the remaining pores of the base material of the separator. During discharging of the battery cell, the lithium ions may diffuse from the remaining pores of the base material of the separator to the cathode. The volume of the separator hereby remains approximately constant. Changes in volume of the separator and of the anode are thus reduced. Mechanical stresses within the battery cell are also reduced in this way.

Moreover, a battery cell is provided which includes at least one separator according to the present invention.

A battery cell according to the present invention is advantageously used in a traction battery of an electric vehicle (EV), in particular a hybrid vehicle (HEV) or a plug-in hybrid vehicle (PHEV), or in a consumer electronic product. Consumer electronic products are understood in particular to mean mobile telephones, tablet PCs, or notebooks.

The separator according to the present invention, in particular the electrolyte layer of the separator, possesses sufficient hardness to provide adequate mechanical resistance against a dendrite growing from the anode. Growth of a dendrite through the separator is thus avoided. In addition, the separator prevents further undesirable components, for example polysulfides, from migrating from the cathode to the anode or in the reverse direction.

In addition, the separator according to the present invention reduces changes in volume of the anode during charging and discharging. Due to the reduced changes in volume, mechanical stresses on the separator, caused by the changes in volume of the anode, are also reduced. The risk of cracks or fractures in the anode is also reduced in this way. In addition, a relatively good connection of the solid electrolyte of the electrolyte layer of the separator to the anode and to the cathode of the battery cell is ensured.

Furthermore, the separator according to the present invention allows a locally resolved current density in the battery cell due to the targeted localized setting of the thickness of the electrolyte layer. This may be advantageously utilized, for example, for sealing the edges of battery cells.

### BRIEF DESCRIPTION OF THE DRAWINGS

Specific embodiments of the present invention are explained in greater detail below with reference to the figures and the description below.

FIG. 1 shows a schematic illustration of a battery cell.

FIG. 2 shows a schematic illustration of the separator and the anode of the battery cell from FIG. 1.

### DETAILED DESCRIPTION OF EXAMPLE EMBODIMENTS

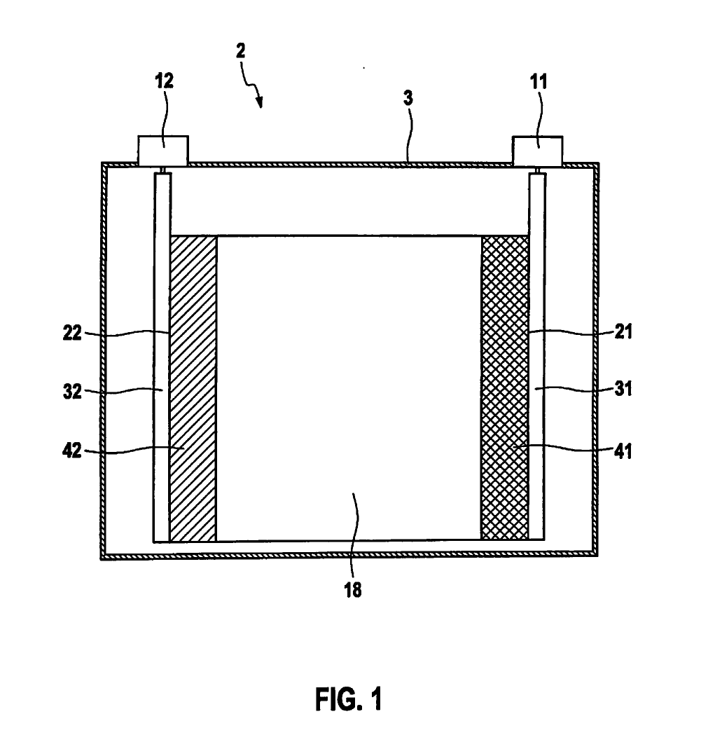

A battery cell 2 is schematically illustrated in FIG. 1. Battery cell 2 includes a cell housing 3 having a prismatic design, in the present case a cuboidal design. In the present case, cell housing 3 has an electrically conductive design and is made of aluminum or stainless steel, for example. However, cell housing 3 may also be made of an electrically insulating material, for example plastic. Other shapes of the cell housing 3, for example cylindrical, are also conceivable. A soft foil may be provided instead of a solid cell housing 3 when battery cell 2 is designed as a pouch cell.

Battery cell 2 includes a negative terminal 11 and a positive terminal 12. A voltage provided by battery cell 2 may be tapped via terminals 11, 12. In addition, battery cell 2 may also be charged via terminals 11, 12. Terminals 11, 12 are situated spaced apart from one another on a top surface of prismatic cell housing 3.

An electrode winding which includes two electrodes, namely, an anode 21 and a cathode 22, is situated within cell housing 3 of battery cell 2. Anode 21 and cathode 22 each have a foil-like design, and are wound to form an electrode winding with a separator 18 situated in between. It is also possible to provide multiple electrode windings in cell housing 3. An electrode stack, for example, may also be provided instead of the electrode winding.

Anode 21 includes an anodic active material 41 which has a foil-like design. Anodic active material 41 contains lithium or a lithium-containing alloy as the base material. Other types of metal electrodes are also possible. Anode 21 also includes a current collector 31, which likewise has a foil-like design. Anodic active material 41 and current collector 31 are placed flatly against one another and joined together.

Current collector 31 of anode 21 has an electrically conductive design and is made of a metal, in the present case, copper. Current collector 31 of anode 21 is electrically connected to negative terminal 11 of battery cell 2 with the aid of a collector.

Cathode 22 includes a cathodic active material 42 which has a foil-like design. Cathodic active material 42 contains a metal oxide, for example lithium-cobalt oxide (LiCoO₂), as the base material. Cathode 22 also includes a current collector 32 which likewise has a foil-like design. Cathodic active material 42 and current collector 32 are placed flatly against one another and joined together.

Current collector 32 of cathode 22 has an electrically conductive design and is made of a metal, for example aluminum. Current collector 32 of cathode 22 is electrically connected to positive terminal 12 of battery cell 2.

Anode 21 and cathode 22 are separated from one another by separator 18. Separator 18 likewise has a foil-like design. Separator 18 has an electrically insulating design, but is ionically conductive, i.e., is permeable for lithium ions.

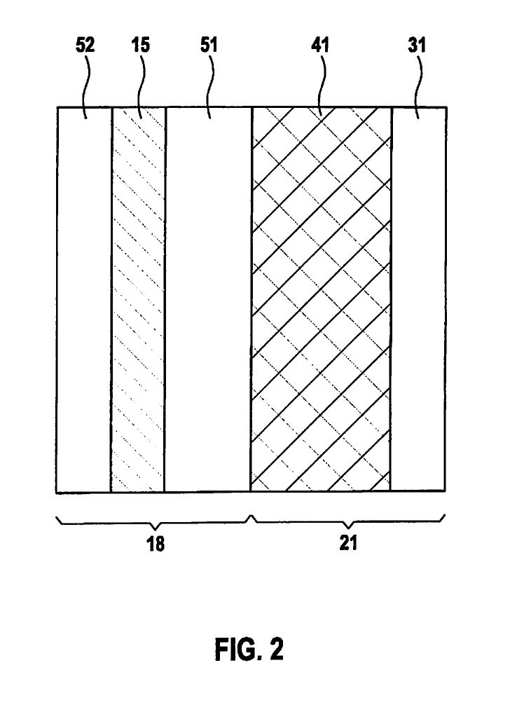

FIG. 2 schematically illustrates separator 18 and anode 21 of battery cell 2 from FIG. 1. Separator 18 includes a mesoporous, mechanically stable base material with continuous pores. The thickness of the base material of separator 18 is between 10 microns and 50 microns, for example. The base material of separator 18 is a ceramic, for example, in particular mesoporous silica.

Separator 18 includes a first intermediate layer 51, an electrolyte layer 15, and a second intermediate layer 52. Electrolyte layer 15 is enclosed by first intermediate layer 51 and second intermediate layer 52. Anodic active material 41 rests against first intermediate layer 51. Current collector 31 of anode 21 is situated on the side of first intermediate layer 51 facing away from anodic active material 41, i.e., opposite from same.

Electrolyte layer 15 is formed by a solid electrolyte that is embedded in the base material of separator 18. The solid electrolyte of electrolyte layer 15 is made of a material that is manufacturable to be relatively thin, in particular an inorganic ceramic material. In the present case, the solid electrolyte of electrolyte layer 15 is made of LiPON.

The introduction of electrolyte layer 15 into the base material of separator 18 takes place with the aid of a vacuum process, for example. Such a vacuum process allows pores of the base material of separator 18 to be filled with the solid electrolyte.

In the present case, first intermediate layer 51 and second intermediate layer 52 of separator 18 contain solid polymers, in particular polyethylene glycol (PEO), with addition of lithium-conducting salts such as LiTFSI.

Alternatively, first intermediate layer 51 and second intermediate layer 52 of separator 18 may contain gel-like, viscous polymers that are in particular impregnated with a liquid electrolyte. The addition of lithium-conducting salts is also conceivable. It is likewise possible for first intermediate layer 51 and second intermediate layer 52 of separator 18 to contain pure liquid electrolytes.

The present invention is not limited to the exemplary embodiments described here and the aspects highlighted therein. Rather, numerous modifications within the range set forth in the claims are possible which are within the scope of activities carried out by those skilled in the art.

1-10. (canceled)

11. A separator for separating an anode and a cathode in a battery cell, the separator including a base material which has a porosity, wherein an electrolyte layer is provided within the base material of the separator, the electrolyte layer being formed by a solid electrolyte and having a lower porosity than the base material of the separator.

12. The separate as recited in claim 11, wherein the base material is ionically conductive.

13. The separator as recited in claim 11, wherein at least one intermediate layer that has a higher porosity than the electrolyte layer is provided within the base material of the separator.

14. The separator as recited in claim 13, wherein the electrolyte layer is situated between a first intermediate layer and a second intermediate layer.

15. The separator as recited in claim 13, wherein the at least one intermediate layer is formed as a solid.

16. The separator as recited in claim 13, wherein the at least one intermediate layer is viscous.

17. The separator as recited in claim 13, wherein the at least one intermediate layer is liquid.

18. The separator as recited in claim 13, wherein the anode includes an anodic active material that adjoins the at least one intermediate layer.

19. The separator as recited in claim 11, wherein the anode includes an anodic active material that protrudes into the base material of the separator.

20. A battery cell that includes a separator for separating an anode and a cathode in a battery cell, the separator including a base material which has a porosity, wherein an electrolyte layer is provided within the base material of the separator, the electrolyte layer being formed by a solid electrolyte and having a lower porosity than the base material of the separator.

21. A traction battery of an electric vehicle, comprising a battery cell that includes a separator for separating an anode and a cathode in a battery cell, the separator including a base material which has a porosity, wherein an electrolyte layer is provided within the base material of the separator, the electrolyte layer being formed by a solid electrolyte and having a lower porosity than the base material of the separator.
